(19) United States
(12) Patent Application Publication
(10) Pub. No.: US 2015/0154368 A1
(43) Pub. Date: Jun. 4, 2015

(54) METHODS AND APPARATUSES USING MOLECULAR FINGERPRINTS TO PROVIDE TARGETED THERAPEUTIC STRATEGIES

(71) Applicant: H. LEE MOFFITT CANCER CENTER AND RESEARCH INSTITUTE, INC., Tampa, FL (US)

(72) Inventors: Johnathan M. Lancaster, Tampa, FL (US); James J. Mulé, Odessa, FL (US)

(21) Appl. No.: 14/413,019

(22) PCT Filed: Jul. 25, 2013
(86) PCT No.: PCT/US2013/052027

§ 371 Date: Jan. 6, 2015

Related U.S. Application Data
(60) Provisional application No. 61/675,575, filed on Jul. 25, 2012.

(51) Int. Cl. G06F 19/00; G06F 17/30

(52) U.S. Cl. CPC G06F 19/345; G06F 17/30345; G06F 19/322

(57) ABSTRACT

Methods and apparatuses using molecular fingerprints to provide targeted therapeutic strategies are disclosed herein. The molecular fingerprints can be maintained and dynamically updated based on newly discovered and relevant information to improve individualized care.

### CROSS-REFERENCE TO RELATED APPLICATIONS

This application claims the benefit of U.S. Provisional Patent Application No. 61/675,575, filed on Jul. 25, 2012, entitled “METHODS AND APPARATUSES USING MOLECULAR FINGERPRINTS TO PROVIDE TARGETED THERAPEUTIC STRATEGIES,” the disclosure of which is expressly incorporated herein by reference in its entirety.

### BACKGROUND

Cancer is the second most frequent cause of death in the U.S. (heart disease is most frequent). In 2012, the American Cancer Society estimates that 1.6 million people will be diagnosed as new cancer cases. Of these existing and new cancer cases in the U.S., more than 575,000 will not live through to 2013. Thus, more than 1,500 Americans a day are expected to die of cancer in 2012. The current survival rate for all cancer types is 67% (based on cases diagnosed from 2001 to 2007). For 2007, the National Institute of Health reports that cancer cost exceeded $226 billion with $103 billion for direct medical costs.

Cure, prolongation of survival and/or the successful maintenance of quality of life remain important goals throughout treatment of cancer. Traditionally, oncologists have used empiric treatment decision-making approaches to chemotherapy selection for patients with cancer. Such tactics frequently result in sub-optimal tumor response rates and can be associated with significant toxicities. Improving the ability to manage the disease by optimizing the use of existing drugs and/or developing new strategies is essential in this endeavor. To this end, individualizing treatments by identifying patients whose tumors are most amenable to treatment with specific targeted agents may increase response rates and limit the incidence and severity of toxicities that not only limit quality of life, but also the patients' ability to tolerate further therapies.

‘One size fits all’ medicine is soon to become a treatment strategy of the past. Personalized medicine is a relatively new, popular and rapidly growing medical model proposing individual customization of healthcare. For example, medical decisions and practices can be tailored to the individual patient through the use of genetic information along with a patient's family history, social circumstances and environment. Furthermore, the concept of personalized medicine is beginning to revolutionize the way pharmaceutical companies design clinical trials—moving away from massive, billion-dollar ‘all-corners welcome’ clinical trials towards smaller, lower cost, tailored trials, the entry requirements for which include specific biologic features to be present. Such changes dramatically decrease trial size and costs, and expedite go/no-go answers in drug development.

Personalized medicine offers many advantages to the patients. For example, the patient's ability to make informed medical decisions is increased. In addition, because therapies are targeted to the individual, higher probabilities of desired outcomes are expected while the probabilities of negative side effects are expected to be reduced. Personalized medicine also focuses on prevention and prediction of disease, which enable earlier detection, instead of reacting to disease diagnosis. Accordingly, personalized medicine is anticipated to reduce healthcare costs.

### SUMMARY

Methods and apparatuses using molecular fingerprints to provide targeted therapeutic and clinical trial strategies are disclosed herein. For example, the molecular fingerprint can be a patient-specific molecular fingerprint including one or more biomarkers that are represented in a cell or tissue sample, as well as one or more drugs (and clinical trials therefore) that target the identified biomarkers. The patient-specific fingerprint provides patients and healthcare providers with a roadmap of molecular biomarkers and signaling pathways—and drugs and clinical trials that target them—in an individual patient's specimens. The patient can use this information much as one would use a traditional roadmap to survey the therapeutic and clinical trial options and select the one that seems most appropriate for the individual patient. As with all clinical and biologic tools, the patient-specific fingerprint provides additional information that can be used to facilitate clinical decision making, but as with all clinical tools (X-Ray, CT scans, blood test, etc.), the patient-specific fingerprint needs to be interpreted in the context of all the other clinical factors that are unique to an individual patient. As such, the patient-specific fingerprint represents a valuable component of personalized care. For example, the patient-specific fingerprint can be used in conjunction with clinical information from the patient's history, physical exams, medical imaging, diagnostic testing, etc. to facilitate personalized decision-making and selection of appropriate clinical trials.

The need for a shift toward personalized patient care is highlighted in the arena of oncology, where there remains a critical need for new drugs, more rational use of existing drugs, and expedited, lower-cost clinical trials. Though many patients with cancer have an interest in enrolling in a clinical trial, identifying an appropriate trial can be cumbersome, time-consuming and challenging for patients. By characterizing unique biologic aspects of a patient's tumor, and identifying drugs that target the unique biologic aspects and associated clinical trials, the patient-specific fingerprint can help patients and their healthcare providers select more personalized treatment plans, while facilitating clinical trial enrollment and decreasing the costs of the clinical trial.

An example method for providing therapeutic strategies can include: receiving data related to a patient's cell or tissue; interpreting the data to identify one or more biomarkers that are represented in the patient's cell or tissue; generating a patient-specific fingerprint that includes the one or more biomarkers and one or more drugs that target at least one of the one or more biomarkers; maintaining the patient-specific fingerprint in a database; periodically updating the patient-specific fingerprint; and displaying the patient-specific fingerprint. When displaying the patient-specific fingerprint, the one or more biomarkers can be displayed in relation to the one or more drugs that target at least one of the one or more biomarkers.

In some implementations, at least one of the one or more biomarkers can be a genomic signature characteristic of the patient's cell or tissue. For example, the genomic signature can be based on information such as DNA, microRNA, messenger RNA, protein, or other biological molecules.

Optionally, the patient-specific fingerprint can include a level of confidence that each of the one or more biomarkers is represented in the patient's cell or tissue. The patient-specific fingerprint can also optionally include information regarding at least one of the one or more biomarkers, information regarding at least one of the one or more drugs that target at least one of the one or more biomarkers or information regarding a clinical trial for at least one of the one or more drugs that target at least one of the one or more biomarkers.

Additionally, the method can include: authenticating an identity of a patient or a healthcare provider; and upon authenticating the identity of the patient or the healthcare provider, providing access to the patient-specific fingerprint. Optionally, the method can also include providing an advertisement relevant to the patient-specific fingerprint. Alternatively or additionally, the method can optionally include prompting the patient for updated information regarding the patient's condition.

In addition to displaying the patient-specific fingerprint, the method can optionally include displaying a link to information regarding at least one of the one or more biomarkers, displaying a link to information regarding at least one of the one or more drugs that target at least one of the one or more biomarkers, displaying a link to information regarding a clinical trial for at least one of the one or more drugs that target at least one of the one or more biomarkers or displaying an advertisement relevant to the patient-specific fingerprint. The additional information can be displayed in relation to the one or more biomarkers, for example.

As discussed above, the method can include periodically updating the patient-specific fingerprint. In some implementations, the patient-specific fingerprint can be updated in response to a newly discovered biomarker that is represented in the patient's cell or tissue. Alternatively or additionally, the patient-specific fingerprint can be updated in response to a newly discovered drug that targets at least one of the one or more biomarkers. The patient-specific fingerprint can optionally be updated in response to a newly discovered clinical trial for a drug that targets at least one of the one or more biomarkers. In some implementations, upon updating the patient-specific fingerprint, the method can include notifying the patient or the healthcare provider of the updated patient-specific fingerprint.

In some implementations, the data related to the patient's cell or tissue is associated with at least one assay of a patient specimen. For example, the patient's cell or tissue can be a tumor. The method can include: providing a patient or a healthcare provider with a plurality of assays; receiving one or more selected assays from the patient or the healthcare provider; and selecting one or more entities to perform the one or more selected assays on the patient specimen. Alternatively or additionally, in some implementations, the data related to the patient's cell or tissue is associated with a pathology test report.

Optionally, the method can include providing a clinical consult based on the patient-specific fingerprint.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a block diagram of a system for providing therapeutic strategies based on a dynamic patient-specific fingerprint;

FIG. 2 is a flow diagram illustrating example operations for providing therapeutic strategies based on a dynamic patient-specific fingerprint;

FIG. 3 is a flow diagram illustrating example operations for providing access to therapeutic strategies based on a dynamic patient-specific fingerprint;

FIG. 4 is a block diagram of an example computing device;

FIG. 5 is an example webpage for displaying therapeutic strategies based on a dynamic patient-specific fingerprint; and

FIG. 6 is an example service provider home webpage.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a”, “an”, “the”, include plural referents unless the context clearly dictates otherwise. The term “comprising” and variations thereof as used herein is used synonymously with the term “including” and variations thereof and are open, non-limiting terms. While implementations will be described for providing therapeutic strategies using dynamic molecular fingerprints of cancer specimens, it will become evident to those skilled in the art that the implementations are not limited thereto, but are applicable for providing therapeutic strategies using dynamic molecular fingerprints of non-cancer specimens (e.g., any type of cell or tissue specimen). For example, the implementations discussed herein are applicable for providing therapeutic strategies using dynamic molecular fingerprints of specimens from patient's having non-cancer diseases such as diabetes, cardiovascular disease, obesity, or any other disease or condition.

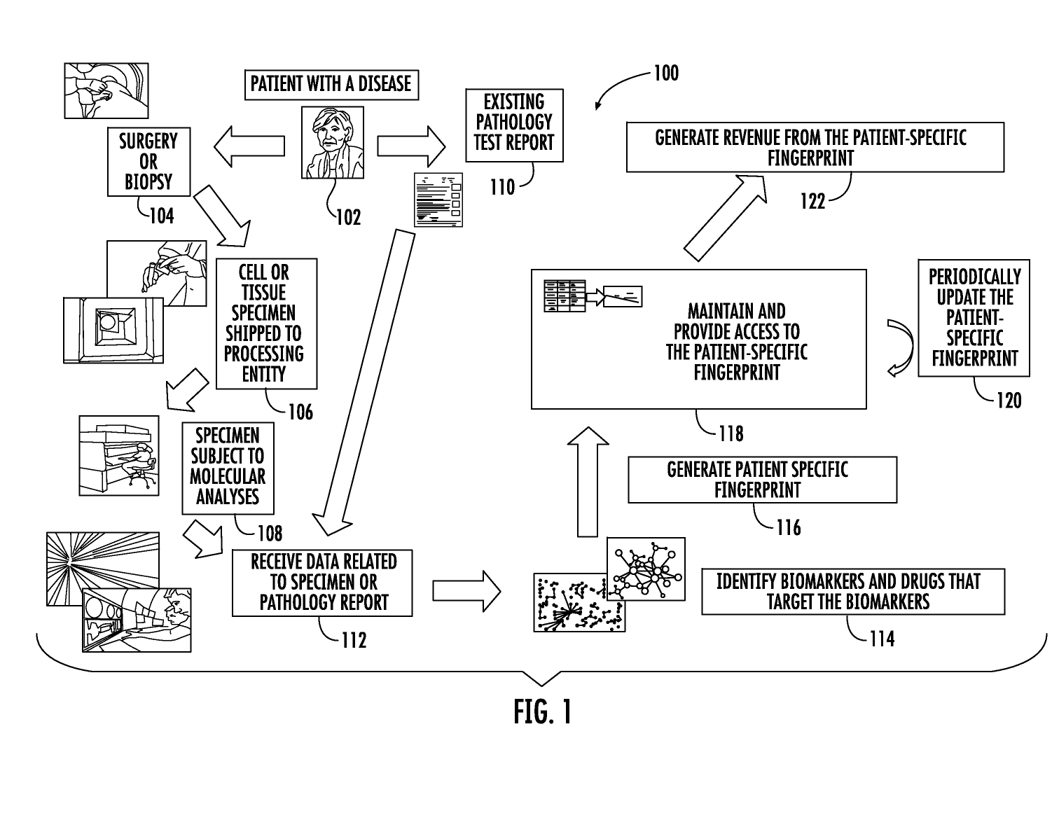

Referring now to FIG. 1, a system 100 for providing therapeutic strategies based on a dynamic patient-specific fingerprint is shown. Using the system 100 of FIG. 1, it is possible to manage collection, shipping, processing, biologic analyses of a cell or tissue sample (“specimen”) (or an existing molecular and/or biologic pathology test report) obtained from an individual patient 102 and generate a patient-specific fingerprint. The patient 102 may be diagnosed with a disease such as cancer, for example. Although the embodiments discussed herein involve a patient with cancer, it should be understood that the patient 102 can have another type of disease or condition such as diabetes, obesity, cardiovascular disease, etc. At 104, a specimen is obtained from the patient 102. In some implementations, a surgical procedure is performed to extract the specimen. For example, a biopsy can be performed on the patient 102 to obtain the specimen. The specimen can be at least a portion of a tumor, for example.

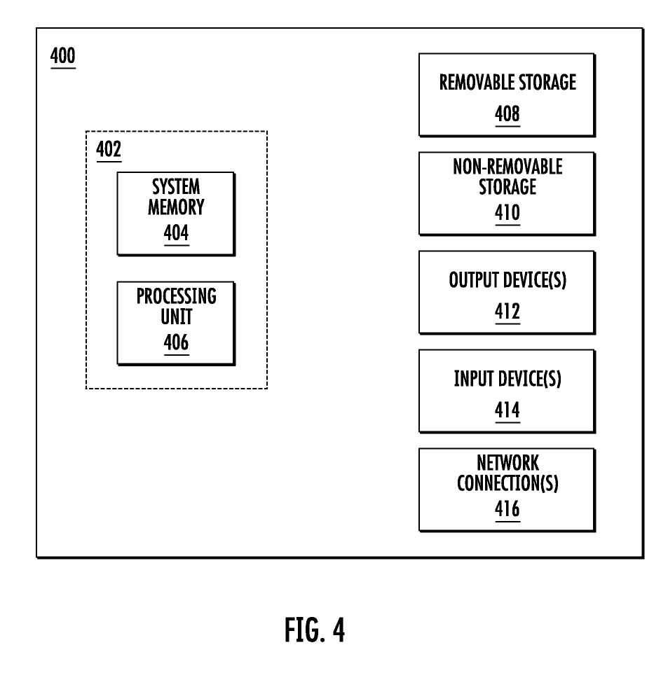

A service provider can coordinate the system 100 shown in FIG. 1. The service provider can provide a cyber-medicine-based assay service to the patients and the patients' healthcare provider. For example, before or after obtaining the specimen, the patient 102 and/or the patient's healthcare provider can register (e.g., provide personal and medical information) with the service provider. It should be understood that the patient's healthcare provider can perform some or all of the steps performed by the patient 102 discussed herein. In some implementations, the patient 102 can register by accessing a webpage hosted on a remote server device using a client device. The client device can be connected to the server device through a communication network such as the Internet, for example. This disclosure contemplates that the client device and the server device can be any type of computing device such as the computing device discussed below with regard to FIG. 4. The client device can be, for example, a desktop computer, laptop computer, tablet computer, mobile computing device, etc. The server device can be one or more computing devices. In some implementations, the server device can be implemented in a cloud computing environment. In a cloud computing environment, it is possible to provide access to a shared pool of computing resources (e.g., networks, servers, storage, applications, services, etc.) that can be provisioned and released with minimal interaction. The communication network can be any type of suitable network including, but not limited to, a local area network (LAN), a wide area network (WAN), a virtual private network (VPN), a wireless area network (WLAN), a metropolitan area network (MAN), etc., including portions and combinations of any of the above networks. This disclosure contemplates that the client device and the server device are coupled to the communication network through one or more suitable communication links. The communication links can be implemented by any medium that facilitates data exchange including, but not limited to, wired, wireless and optical links.

The patient 102 can therefore register by submitting the registration information over the communication network. Alternatively or additionally, the patient 102 can obtain (e.g., via electronic download) appropriate registration forms, which can be completed and shipped with the specimen and entered by the service provider. Upon registering, an account can be established for the patient 102. The account can optionally be a secure account such as a secure webpage. For example, access to the account can be password-protected. Alternatively or additionally, other suitable security features to protect the account can be provided. At 106, the patient 102 can ship the specimen to one or more processing entities. The specimen can be shipped to the processing entities by mail, parcel service, courier service, or any other shipping service. The specimen can be handled according to suitable protocols to maintain the integrity of the specimen. For example, the specimen can be frozen or paraffin embedded. The processing entities can be traditional biotechnology laboratory assay companies (e.g., LABCORP, QUEST, GENOMIC HEALTH, etc.). The processing entities can also be specialized biotechnology laboratory assay companies. In some implementations, the service provider can coordinate selection and shipment options when the patient 102 registers with the service provider. In other implementations, the patient 102 can coordinate selection and shipment options.

Optionally, it is possible to provide the patient 102 with a list of assays from which to choose. The service provider can provide the list of assays at its webpage, for example. The patient 102 can then select from the list of assays. The patient 102 can choose to have any number of the assays performed on the specimen. After selecting one or more assays from the list, the processing entities to perform the assays can optionally be selected. In some implementations, the service provider can select the processing entities to perform the selected assays. For example, after receiving the patient's selected assays, the service provider can select suitable processing entities. The patient 102 can be provided with shipping forms (e.g., via electronic download) for the specimen. The specimen can be shipped directly to the service provider, which can act as a clearing house and ship the specimen to the suitable processing entities. Alternatively, the specimen can be shipped directly to the suitable processing entities.

At 108, the specimen is subject to molecular analyses by the processing entities. The biologic data related to the patient's specimen is transmitted by the processing entities and received by the service provider at 112. The data can be raw data in a standard data format. In some implementations, the data can be transmitted to the service provider over the communication network. In other implementations, the data can be transmitted to the service provider on tangible, computer-readable media, in hard copy, or in any suitable format. After receiving the data, the data is subject to bioinformatics analysis at 114, which includes advanced computational and biostatistical techniques to identify one or more biomarkers that are represented in the specimen. The biomarkers can be based on information from genetic sequence or structure alternation (DNA), gene expression (microRNA or messenger RNA) and/or protein levels. For example, the level of activity of genes (i.e., thousands of genes) in the specimen such as a cancer specimen can be analyzed. Through this analysis, patterns of gene expression (or genomic signatures, fingerprints or profiles) or other biological features characteristic of the specimen can be identified. This information can be used to identify discrete, activated, disease-related pathways within the specimen, and the pathways represent novel opportunities for treatment. When the disease is cancer, the information can be used to identify cancer-related pathways, which represent novel opportunities for cancer treatment. Specifically, one or more drugs that target (i.e., induce cell death and tumor regression, for example) each of the identified biomarkers represented in the specimen can be identified.

At 116, a patient-specific fingerprint can be generated that includes the one or more biomarkers that are represented in the specimen, as well as one or more drugs that target at least one of the one or more biomarkers (if a drug exists). Optionally, the patient-specific fingerprint can also include measures of statistical probability and/or levels of confidence that each of the one or more biomarkers are represented in the specimen. Alternatively or additionally, the patient-specific fingerprint can include information regarding at least one of the one or more biomarkers, information regarding at least one of the one or more drugs that target at least one of the one or more biomarkers and/or information regarding clinical trials for at least one of the one or more drugs. For example, the information can be provided by the service provider or provided by another source (e.g., pharmaceutical companies, biotechnology companies, medical information companies, diagnostic companies, hospitals, cancer or other treatment centers, supportive care companies, physician groups, or any other source). The information can be educational information, product information, advertising information, regulatory information, or any type of information.

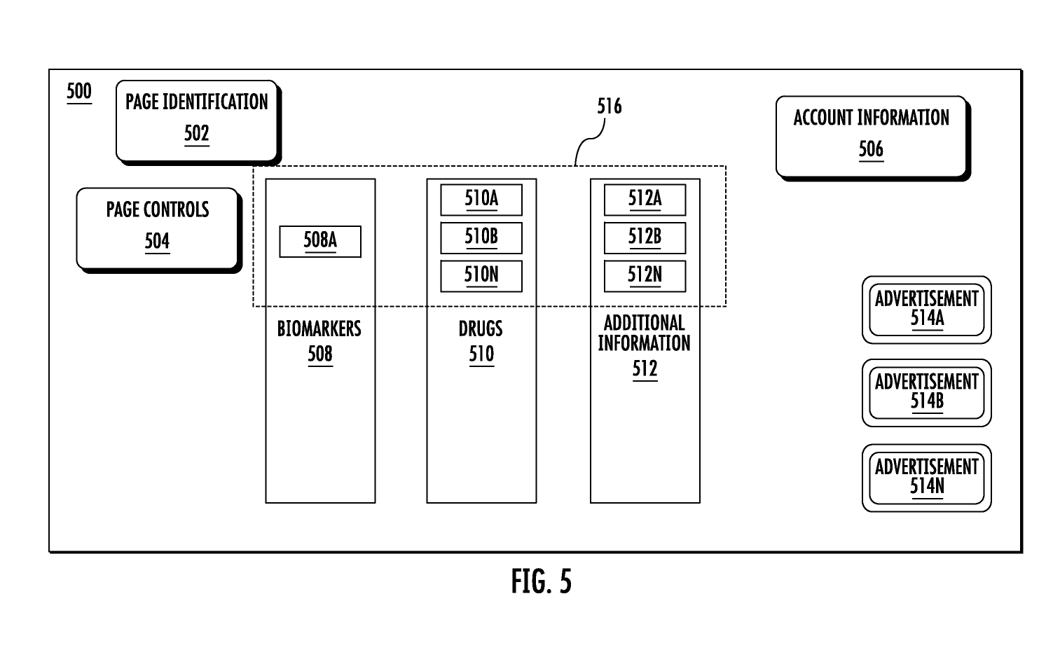

At 118, the patient-specific fingerprint can be maintained, for example, in a database. The database can include a plurality of patient-specific fingerprints. In some implementations, the patient-specific fingerprint can be maintained by the service provider on the server device discussed above. Additionally, the patient-specific fingerprint can be made available to the patient 102 and/or the patient's healthcare provider. For example, the patient-specific fingerprint can be made available via a password-protected fingerprint webpage, which can be used by the patient 102 and/or the patient's healthcare provider to aid clinical therapeutic decision-making Referring now to FIG. 5, an example webpage 500 for displaying therapeutic strategies based on a dynamic patient-specific fingerprint is shown. The webpage 500 can include page identification 502 (e.g., the service provider's information), account information 506 (e.g., the patient 102 or the healthcare provider's information), page controls 504 (e.g., customary webpage controls and functions), and any other suitable information and/or controls.

The basic content and webpage layout are well known in the art and need not be discussed at length here. The webpage 500 can be tailored to address the needs of specific users—patients, healthcare providers, pharmaceutical companies, clinical trial sponsors, etc.—after obtaining required consent and complying with appropriate regulations (e.g., HIPAA). The webpage 500 can also contain multiple data harvesting opportunities to benefit patients through increased adjustments to the provided information based on medical advancements. The webpage 500 can be user-friendly and include functionality such as a concierge available at the push of a button or a pop-up assistance window from the service provider's support staff to assist patients in their endeavors to get help for their cancer treatment online. The webpage 500 can also provide blogging opportunities for patients to share their experiences, as well as related resources in addressing the whole patient, not just in treating their cancer but to help with dietary choices and social and emotional requirements.

The list of one or more biomarkers represented in the specimen 508 can be displayed on the webpage 500. In addition, the list of one or more drugs that target at least one of the one or more biomarkers 510 can be displayed on the webpage 500 in relation to the list of one or more biomarkers 508. Optionally, the additional information 512 regarding the one or more biomarkers, the one or more drugs that target at least one of the one or more biomarkers and/or the clinical trials can be displayed on the webpage 500. In some implementations, the additional information 512 can include one or more links to information regarding the one or more biomarkers, information regarding at least one of the one or more drugs that target at least one of the one or more biomarkers and/or information regarding clinical trials for at least one of the one or more drugs that target at least one of the one or more biomarkers. For example, as shown in FIG. 5, a biomarker 508A is displayed in a portion 516 of the webpage 500. The drugs 510A, 510B . . . 510N that target biomarker 508A are also displayed in the portion 516 of the webpage 500. The additional information 512A, 512B . . . 512N is also displayed in the portion 516 of the webpage 500. In some implementations, the portion 516 of the webpage 500 can be separate from other information on the webpage 500 such that the one or more drugs that target each of the one or more biomarkers and information pertaining thereto can be visually distinguished from other information on the webpage 500. Alternatively or additionally, the biomarker 508, the drugs 510A, 510B . . . 510N and/or the additional information 512A, 512B . . . 512N can be links. For example, the additional information 512A can be a link to additional information regarding the biomarker 508 (e.g., education information). The additional information 512B can be a link to additional information regarding one or more of the drugs 510A, 510B . . . 510N (e.g., educational information, product information, advertising information, clinical trial information, etc.). The additional information 512N can be a link to one or more clinical trials. For example, the link can be a direct link to information provided by a clinical trial sponsor (e.g., a pharmaceutical company, a biotechnology company, diagnostic company, hospital, treatment center, a supportive care company, physician group, or any other sponsor) or a neutral entity (e.g., a government-sponsor website). As discussed above, the additional information can be provided by the service provider or any other source. Optionally, the additional information available to the patient 102 can be the same as the information available to the patient's healthcare provider in one or more respects. Or, the additional information available to the patient 102 can be different from the information available to the patient's healthcare provider in one or more respects (e.g., tailored to the patient's healthcare provider with more in-depth, medical information). It should be understood that the webpage 500 shown in FIG. 5 is only one example webpage and that the content and webpage format can take many other forms.

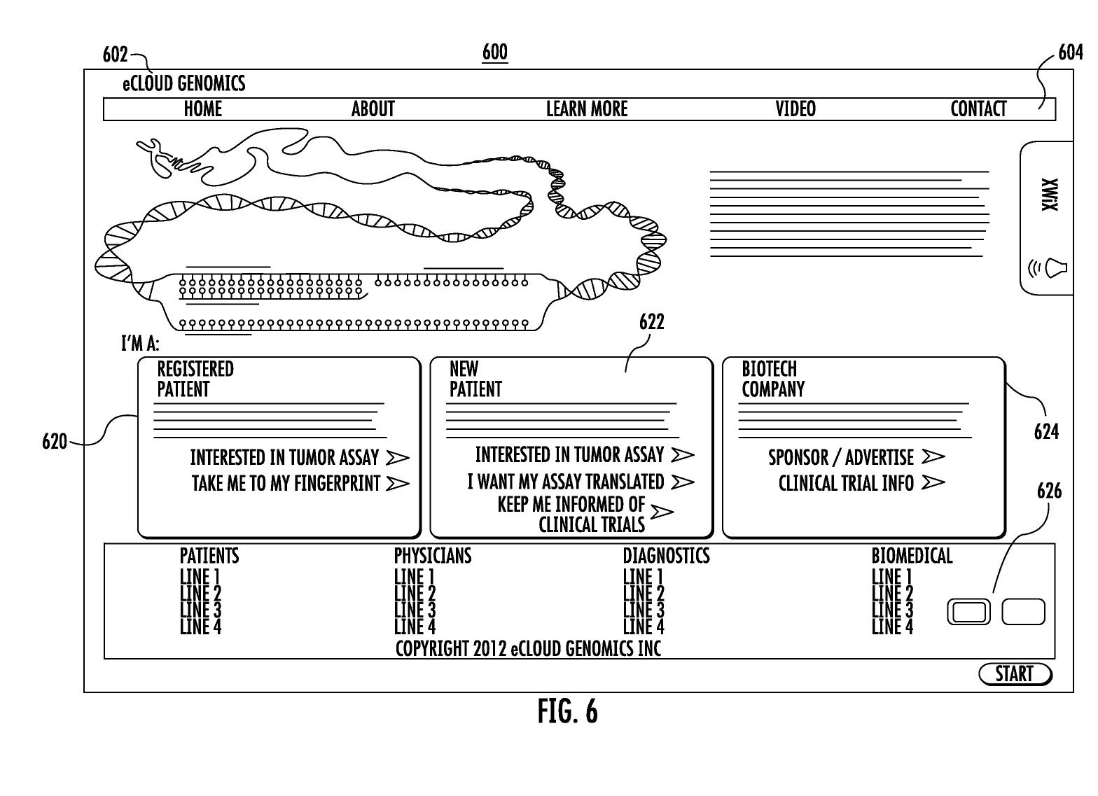

Referring now to FIG. 6, another example service provider webpage 600 is shown. The webpage 600 can be the service provider's home webpage, for example. As discussed above, the basic content and webpage layout are well known in the art and need not be discussed at length here. The webpage 600 can include page identification 602 (e.g., the service provider's information) and page controls 604 (e.g., customary webpage controls and functions). In FIG. 6, the page controls 604 can include a plurality of links to additional web pages containing additional information (i.e., About, Learn More, Video, Contact, etc.). The webpage 600 can also optionally include links to social media 626, for example. Additionally, the webpage 600 can include a registered patient sign-in window 620, a new patient sign-in window 622 and a biotech company sign-in window 624. The registered patient sign-in window 620 presents the returning patient with options such as accessing the patient-specific fingerprint and/or obtaining information regarding assay services. For example, when an existing patient selects an option from the registered patient sign-in window 620, the patient is prompted to enter a password to before being provided access to a secure profile webpage. The new patient sign-in window 622 presents a new patient with options such as obtaining information regarding assay services, obtaining information regarding bioinformatics analyses and/or obtaining information regarding clinical trials. When a new patient selects an option from the new patient sign-in window 622, the patient can be prompted with a series of questions in order to collect patient information. Thereafter, the patient can be provided with a secure profile webpage. The biotech company (or pharmaceutical company, clinical trial sponsor, or any other type of entity) sign-in webpage 624 presents the biotech company with access to the service provider's webpage. Using the biotech company sign-in webpage 624, the entity can pursue advertising opportunities and/or clinical trial opportunities, for example. It should be understood that the webpage 600 shown in FIG. 6 is only one example webpage and that the content and webpage format can take many other forms.

At 120, the patient-specific fingerprint can be periodically updated. The patient-specific fingerprint is dynamic and is updated as new information becomes available. For example, the patient-specific fingerprint can be updated as knowledge of the disease, biomarkers, drugs and/or clinical trials evolve. In some implementations, the patient-specific fingerprint is updated when new biomarkers are identified. For example, the biologic data related to the specimen may be interpreted differently as technology advances, and therefore, new biomarkers that are represented in the specimen may be identified. Alternatively or additionally, the patient-specific fingerprint is updated when new drugs that target known biomarkers are discovered. As technology advances, new biologic targets for existing drugs and/or new drugs are discovered. In other words, knowledge of biomarkers and drugs that target the biomarkers evolve over time. Alternatively or additionally, the patient-specific fingerprint is updated when a new clinical trial is discovered. Accordingly, the patient-specific fingerprint is dynamic and is updated based on recently-discovered information. In this way, the patient-specific fingerprint evolves as the state-of-the-art of knowledge of biology and targeted therapies evolve. In some implementations, it is possible to notify the patient 102 in response to updating the patient-specific fingerprint. It should be understood that the patient 102 can be notified by any suitable means including, but not limited to, email, regular mail, telephone, instant message, text message, etc. For example, during the registration process, the patient may specify a preferred means of notification.

Alternatively to providing the specimen, the patient 102 can provide a pathology test report such as a molecular or biologic pathology test report, for example. In some cases, the patient 102 may not have access to the specimen. The pathology test report includes information regarding the patient's disease. For example, when the patient 102 has cancer, the pathology test report can include ER/PR status, p53 expression, Her2/neu, etc. Before or after registering with the service provider as discussed above, the pathology test report is received by the service provider at 112. The pathology test report can be transmitted electronically (e.g., email or electronic upload), by mail, by parcel service, etc. Upon receipt, the pathology test report, which contains data related to the patient's diseased cell or tissue, is subject to bioinformatics analysis at 114 to identify one or more biomarkers. This analysis integrates molecular information provided by the pathology test report with knowledge of how the reported biomarkers relate to known molecular signaling pathways and drugs that target the pathways and biomarkers. Using this information, the patient-specific fingerprint is generated at 116. When the patient-specific fingerprint is generated from a pathology test report, it is possible to enable patients who do not have access to the specimen for analysis by the processing entities to obtain a patient-specific fingerprint. Additionally, it is possible to enable a much broader array of patients to participate in an e-community (discussed below).

The patient-specific fingerprint can optionally include information regarding clinical trials. One of the greatest challenges faced by patients with recurrent or chemo-resistant cancer is a lack of therapeutic opportunities. Patients may exhaust all standard-of-care drugs yet wish to continue to be treated. These patients may benefit from clinical trials of new biologically-targeted agents (plus/minus existing agents) and are very frequently highly motivated to identify and participate in such clinical trials. However, patients typically encounter substantial challenges in identifying appropriate clinical trials, which often results in significant delays to initiation of treatment and sometimes represent hurdles that are insurmountable before the patients' demise. By including information regarding clinical trials (e.g., direct links to information regarding appropriate clinical trials from the identified biomarkers and/or drugs) in the patient-specific fingerprint, it is possible to remove or reduce the challenges discussed above. For example, the patients can identify clinical trial options (i.e., without making cold-calls to cancer centers world-wide) and obtain geographic and contact information for appropriate clinical trials more easily. The patients can also obtain information regarding the clinical trials and/or drugs involved, including eligibility criteria, stage of the trials, inclusion/exclusion criteria, risks and benefits, etc. In this way, patients can review clinical trial options that are appropriate for the unique biology of their disease, as well as understand some of the details of the clinical trial, by accessing their patient-specific fingerprints, which can increase enrollment while decreasing length and cost of the clinical trials. The service provider can serve as a registry for patients with an interest in clinical trials, and moreover, act as a resource for patients to identify clinical trials for which they are eligible. This helps patients identify clinical trials for which they are clinically and/or biologically eligible. Thus, unlike the traditional clinical trial model in which clinical trial sponsors identify eligible patients, the patients are able to identify appropriate clinical trials.

In some implementations, a molecular consultation regarding the patient-specific fingerprint can be provided. For example, the patient 102 who elects to take advantage of this service can have the patient-specific fingerprint interpreted by a clinical consultant. The clinical consultant (e.g., staff oncologist, for example) may be a recognized expert in genomic and molecular analyses and the use of targeted therapies. In some implementations, the clinical consultant may perform advanced computational and biostatistical techniques to identify one or more biomarkers that are represented in the specimen as discussed above. The clinical consultant can make specific treatment recommendations using the patient-specific fingerprint in conjunction with knowledge of the patient's specific clinical history (e.g., clinical information from the patient's history, physical exams, medical imaging, diagnostic testing, etc.).

The patient-specific fingerprint can also serves as a portal to an online e-community defined by individual disease signatures and biomarkers. The service provider can provide access to the e-community before or after the patient 102 provides a specimen or a pathology test report by creating a patient account. Alternatively or additionally, the service provider can provide access to a patient who does not provide either a specimen or a pathology test report by creating a patient account. For example, some patients may not have access to either a specimen or a pathology test report but may be interested in joining the e-community. Thus, the patient can gain access to the online e-community by registering without providing a specimen or a pathology test report. For these patients, a patient-specific fingerprint cannot be generated because there is no data to analyze. However, by registering with the service provider, these patients can gain access to the e-community. Using the e-community, patients can interact and share information, experiences, support and resources with other patients who have activation of the same specific pathways or share common biomarkers. In this way, it is possible for patients to share how they have responded to specific therapies and clinical interventions. This information can be tracked and used to further inform the service provider of biomarkers, pathways, drugs and clinical outcomes. This information can also be used to generate revenue (discussed below) from entities that wish to target patients meeting specific criteria. Alternatively or additionally, it is possible to provide educational information on a range of topics relative to oncology, molecular medicine and personalized cancer care using the e-community. As such, it can serve as a resource for individuals who have an interest in these topics regardless of whether the patients have access to the specimen the or pathology test report discussed above. Additionally, patients that register with the service provider without providing a specimen or pathology test report can obtain information about clinical trials by registering with the service provider. Although these patients do not have a patient-specific fingerprint, these patient may be interested in participating in clinical trials. By accessing the service provider's website, these patients can find clinical trials for which they may be eligible.

At 122, it may be possible to generate revenue from the system 100. For example, the service provider can collect fees for coordinating the molecular analyses/assays of the specimen. Alternatively or additionally, the service provider can collect fees for identifying the biomarkers in the specimen and/or generating the patient-specific fingerprint. The service provider can also collect fees for generating the patient-specific fingerprint based on the pathology test report (i.e., when the patient 102 does not provide a specimen). In addition, the service provider can collect fees for creating an account for a patient that does not provide a specimen or a pathology test report (e.g., access to the e-community). Additionally, the service provider can collect fees for providing the clinical consultation based on the patient-specific fingerprint. These fees can be collected from the patient 102, a third party (e.g., an insurance company), etc. In some implementations, these fees can be collected when the patient 102 registers with the service provider, for example.

The service provider can also collect fees from pharmaceutical companies, biotech companies, clinical trial sponsors, diagnostic companies, hospitals, cancer or other treatment centers, supportive care service companies, physician groups, and/or other non-medical/biotech commercial entities. For example, the service provider can collect advertising fees. As shown in FIG. 5, the webpage 500 can include advertisements 514A, 514B . . . 514N. The advertisements 514A, 514B . . . 514N can be pop-up ads, banner ads, or ads displayed in any manner on the webpage 500. The advertisements 514A, 514B . . . 514N can be for any type of service and/or product. In some implementations, the advertisements 514A, 514B . . . 514N are related to pharmaceutical or medical products, clinical trials, etc., for example. Fees can be collected for providing/displaying the advertisements 514A, 514B . . . 514N and/or on a fee-per click basis. In some implementations, the advertisements 514A, 514B . . . 514N can be related to the patient-specific fingerprint. Specifically, the advertisements 514A, 514B . . . 514N can be targeted based on information included in the patient-specific fingerprint. For example, the advertisements 514A, 514B . . . 514N can be for one of the drugs that targets a specific biomarker represented in the specimen and/or a clinical trial for which the patient 102 is a suitable candidate. The e-community discussed above can also provide additional revenue opportunities from pharmaceutical companies, biotech companies, clinical trial sponsors, diagnostic companies, hospitals, cancer centers, supportive care service companies, physician groups, and non-medical/biotech commercial entities wishing to connect with individuals who have specific cancers, specific biologic features or who have simply self-declared themselves to me motivated towards pro-activity relating to cancer care and those that have defined themselves as motivated to learn more about the disease. Additionally, the service provider can collect revenues by maintaining a database of clinical trials. For example, with web-links to clinical trials included in the patient-specific fingerprint, pharmaceutical and/or clinical trial sponsors can register in the service provider's clinical trial database for a fee, and the appropriate clinical trials can be included in the patient-specific fingerprint.

It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

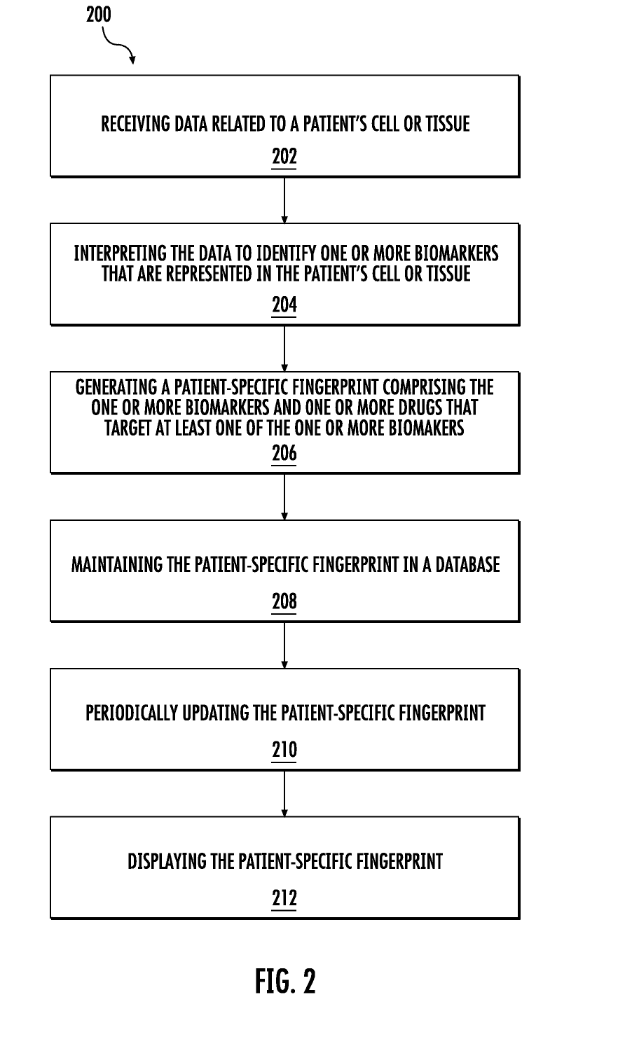

Referring now to FIG. 2, a flow diagram 200 illustrating example operations for providing therapeutic strategies based on a dynamic patient-specific fingerprint is shown. At 202, data related to a patient's cell or tissue is received. As discussed above, the data related to the patient's cell or tissue can be the raw data associated with one or more assays performed on the patient's cell or tissue or based on a pathology test report. After receiving the data, the data can be interpreted to identify one or more biomarkers that are represented in the patient's cell or tissue at 204. Then, at 206, a patient-specific fingerprint that includes the one or more biomarkers and one or more drugs that target at least one of the one or more biomarkers can be generated. Optionally, the patient-specific fingerprint can also include additional information regarding the one or more biomarkers, the one or more drugs that target at least one of the one or more biomarkers and/or clinical trials. At 208, the patient-specific fingerprint can be maintained in a database. The patient-specific fingerprint can be periodically updated at 210 such as, for example, in response to discovering a new biomarker, a new drug and/or a new clinical trial. At 212, the patient-specific fingerprint can be displayed. For example, the one or more biomarkers can be displayed in relation to the one or more drugs that target at least one of the one or more biomarkers.

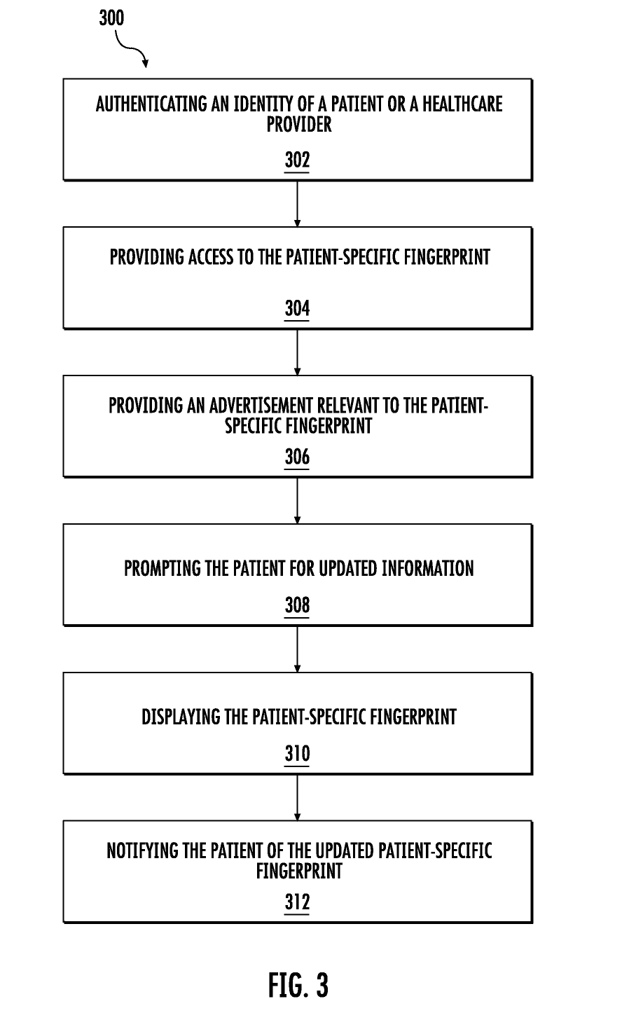

Referring now to FIG. 3, a flow diagram 300 illustrating example operations for providing access to therapeutic strategies based on a dynamic patient-specific fingerprint is shown. After creating and maintaining a database including a plurality of patient-specific fingerprints, it is possible to provide access to the database. For example, patients and/or healthcare providers can be provided with access. For example, at 302, the identity of a patient or a healthcare provider can be authenticated. Thereafter, at 304, access can be provided to the patient or the healthcare provider. In some implementations, the patient or the healthcare provider is provided access through secure webpage. At 306, an advertisement can optionally be provided. For example, the advertisement can be relevant to the information included in the patient-specific fingerprint. At 308, the patient can optionally be prompted to update information regarding the patient's condition. This information may include personal and/or medical information such as information regarding recent developments in the patient's disease type, disease stage and/or disease pathology. Alternatively or additionally, this information may include whether or not the patient's condition improved in response to a particular treatment regimen. At 310, the patient-specific fingerprint can optionally be displayed. For example, as discussed above, the patient-specific fingerprint can be displayed via a secure webpage. Additionally, at 312, the patient can optionally be notified of any update to the patient-specific fingerprint.

When the logical operations described herein are implemented in software, the process may execute on any type of computing architecture or platform. For example, referring to FIG. 4, an example computing device upon which embodiments of the invention may be implemented is illustrated. The computing device 400 may include a bus or other communication mechanism for communicating information among various components of the computing device 400. In its most basic configuration, computing device 400 typically includes at least one processing unit 406 and system memory 404. Depending on the exact configuration and type of computing device, system memory 404 may be volatile (such as random access memory (RAM)), non-volatile (such as read-only memory (ROM), flash memory, etc.), or some combination of the two. This most basic configuration is illustrated in FIG. 4 by dashed line 402. The processing unit 406 may be a standard programmable processor that performs arithmetic and logic operations necessary for operation of the computing device 400.

Computing device 400 may have additional features/functionality. For example, computing device 400 may include additional storage such as removable storage 408 and non-removable storage 410 including, but not limited to, magnetic or optical disks or tapes. Computing device 400 may also contain network connection(s) 416 that allow the device to communicate with other devices. Computing device 400 may also have input device(s) 414 such as a keyboard, mouse, touch screen, etc. Output device(s) 412 such as a display, speakers, printer, etc. may also be included. The additional devices may be connected to the bus in order to facilitate communication of data among the components of the computing device 400. All these devices are well known in the art and need not be discussed at length here.

The processing unit 406 may be configured to execute program code encoded in tangible, computer-readable media. Computer-readable media refers to any media that is capable of providing data that causes the computing device 400 (i.e., a machine) to operate in a particular fashion. Various computer-readable media may be utilized to provide instructions to the processing unit 406 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 406 may execute program code stored in the system memory 404. For example, the bus may carry data to the system memory 404, from which the processing unit 406 receives and executes instructions. The data received by the system memory 404 may optionally be stored on the removable storage 408 or the non-removable storage 410 before or after execution by the processing unit 406.

Computing device 400 typically includes a variety of computer-readable media. Computer-readable media can be any available media that can be accessed by device 400 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for providing therapeutic strategies, comprising:
receiving data related to a patient's cell or tissue;
interpreting the data to identify one or more biomarkers that are represented in the patient's cell or tissue;
generating a patient-specific fingerprint comprising the one or more biomarkers and one or more drugs that target at least one of the one or more biomarkers;
maintaining the patient-specific fingerprint in a database;
periodically updating the patient-specific fingerprint; and
displaying the patient-specific fingerprint, wherein the one or more biomarkers are displayed in relation to the one or more drugs that target at least one of the one or more biomarkers.

2. The method of claim 1, wherein at least one of the one or more biomarkers comprises a genomic signature characteristic of the patient's cell or tissue.

3. The method of claim 2, wherein the genomic signature is based on information from at least one of DNA, microRNA, messenger RNA and protein.

4. The method of claim 1, further comprising:
authenticating an identity of a patient or a healthcare provider; and
upon authenticating the identity of the patient or the healthcare provider, providing access to the patient-specific fingerprint.

5. The method of claim 4, wherein the patient-specific fingerprint further comprises a level of confidence that each of the one or more biomarkers is represented in the patient's cell or tissue.

6. The method of claim 4, wherein the patient-specific fingerprint further comprises information regarding one or more of at least one of the one or more biomarkers, at least one of the one or more drugs that target at least one of the one or more biomarkers, or a clinical trial for at least one of the one or more drugs that target at least one of the one or more biomarkers.

7. (canceled)

8. (canceled)

9. (canceled)

10. (canceled)

11. (canceled)

12. (canceled)

13. (canceled)

14. The method of claim 1, further comprising displaying an advertisement relevant to the patient-specific fingerprint.

15. The method of claim 1, wherein periodically updating the patient-specific fingerprint further comprises updating the patient-specific fingerprint in response to at least one of a newly discovered biomarker that is represented in the patient's cell or tissue, a newly discovered drug that targets at least one of the one or more biomarkers, or a newly discovered clinical trial for a drug that targets at least one of the one or more biomarkers.

16. (canceled)

17. (canceled)

18. (canceled)

19. (canceled)

20. The method of claim 19, further comprising:
providing a patient or a healthcare provider with a plurality of assays;
receiving one or more selected assays from the patient or the healthcare provider; and
selecting one or more entities to perform the selected assays on the patient specimen.

21. The method of claim 1, wherein the data related to the patient's cell or tissue is associated with a pathology test report.

22. (canceled)

23. (canceled)

24. A computing device for providing therapeutic strategies, comprising:
a processing unit; and
a memory operably coupled to the processing unit, the memory having computer-executable instructions stored thereon that, when executed by the processing unit, cause the computing device to:
receive data related to a patient's cell or tissue;
interpret the data to identify one or more biomarkers that are represented in the patient's cell or tissue;
generate a patient-specific fingerprint comprising the one or more biomarkers and one or more drugs that target at least one of the one or more biomarkers;
maintain the patient-specific fingerprint in a database;
periodically update the patient-specific fingerprint; and
provide the patient-specific fingerprint for display, wherein the one or more biomarkers are displayed in relation to the one or more drugs that target at least one of the one or more biomarkers.

25. The computing device of claim 24, wherein at least one of the one or more biomarkers comprises a genomic signature characteristic of the patient's cell or tissue.

26. The computing device of claim 25, wherein the genomic signature is based on information from at least one of DNA, microRNA, messenger RNA and protein.

27. The computing device of claim 24, wherein the memory has further computer-executable instructions stored thereon that, when executed by the processing unit, cause the computing device to:
authenticate an identity of a patient or a healthcare provider; and
upon authenticating the identity of the patient or the healthcare provider, provide access to the patient-specific fingerprint.

28. The computing device of claim 27, wherein the patient-specific fingerprint further comprises a level of confidence that each of the one or more biomarkers is represented in the patient's cell or tissue.

29. The computing device of claim 27, wherein the patient-specific fingerprint further comprises information regarding one or more of at least one of the one or more biomarkers, at least one of the one or more drugs that target at least one of the one or more biomarkers, or a clinical trial for at least one of the one or more drugs that target at least one of the one or more biomarkers.

30. (canceled)

31. (canceled)

32. (canceled)

33. (canceled)

34. (canceled)

35. (canceled)

36. (canceled)

37. The computing device of claim 24, wherein the memory has further computer-executable instructions stored thereon that, when executed by the processing unit, cause the computing device to provide an advertisement relevant to the patient-specific fingerprint for display in relation to the patient-specific fingerprint.

38. The computing device of claim 24, wherein periodically updating the patient-specific fingerprint further comprises updating the patient-specific fingerprint in response to at least one of a newly discovered biomarker that is represented in the patient's cell or tissue, a newly discovered drug that targets at least one of the one or more biomarkers, or a newly discovered clinical trial for a drug that targets at least one of the one or more biomarkers.

39. (canceled)

40. (canceled)

41. (canceled)

42. (canceled)

43. The computing device of claim 42, wherein the memory has further computer-executable instructions stored thereon that, when executed by the processing unit, cause the computing device to:
provide a patient or a healthcare provider with a plurality of assays;
receive one or more selected assays from the patient or the healthcare provider; and
select one or more entities to perform the selected assays on the patient specimen.

44. The computing device of claim 24, wherein the data related to the patient's cell or tissue is associated with a pathology test report.

45. (canceled)

46. (canceled)
